(19) United States
(12) Patent Application Publication
(10) Pub. No.: US 2018/0290234 A1
(43) Pub. Date: Oct. 11, 2018

(54) COMPOSITE PRINTING DEVICE FEATURING MULTI-SPINDLE HIGH-ENERGY-PARTICLE-BEAM DEPOSITION WELDING AND MILLING

(71) Applicant: ASIAN AMERICAN INDUSTRIAL MANUFACTURING, INC., Dongguan, Guangdong (CN)

(72) Inventor: Jian FENG, Dongguan, Guangdong (CN)

(21) Appl. No.: 15/567,611

(22) PCT Filed: Jan. 20, 2017
(86) PCT No.: PCT/CN2017/071779

§ 371 Date: Oct. 19, 2017

(30) Foreign Application Priority Data
Oct. 13, 2016 (CN) 201610893661.0

(51) Int. Cl. B23K 26/00; B23P 23/04; B23K 26/08; B23K 26/342

(52) U.S. Cl. CPC B23K 26/0093; B23K 26/342; B23K 26/0853; B23P 23/04

(57) ABSTRACT

A composite printing device featuring multi-spindle high-energy-particle-beam deposition welding and milling, comprising a machine base, a workbench, a multi-spindle milling device, the multi-spindle milling device including a milling base and a tool base; the workbench including an ejector base, the ejector base fitted with a welding gun. Through the guide of the first rail and second rail, the horizontal distance between the milling base and the workbench or the ejector base can be adjusted, so that the milling base can move to the upper side of the workbench or ejector base; and the milling clamp can hold the tool or welding gun to form a one-layer or multi-layer approximate shape on the workbench and to conduct profile milling, so as to obtain the right size and surface accuracy required for the mechanical part, removing the need for further processing.

### 1. FIELD OF THE INVENTION

The present invention relates generally to a 3D printing device, and more particularly to a composite printing device featuring multi-spindle high-energy-particle-beam deposition welding and milling.

### 2. DESCRIPTION OF RELAXED ART

3D printing technology is an emerging method of formation, which converts the complex 3D shape of an expected workpiece into a simple combination of 2D sections through a slicing process. In this way, traditional machine tools and processing dies are no longer necessary. Based on a three-dimensional CAD model of the workpiece, a computer-controlled rapid prototyping machine forms a series of 2D thin section layers through deposition of material along the height direction, and the series of thin layers are bound together to finally form a 3D workpiece, 3D printing technology can form workpieces reaching the strength level for casting, but the prototypes usually have a large shape error and a coarse surface. Thus, the prototypes need further processing using traditional mechanical tooling methods to obtain the right shape and surface accuracy required by precision mechanical manufacturing industries. In the aerospace industry, most parts (like engine nozzles, blades, and combustion chambers of a honeycomb structure) are in the structure of complex thin walls, or in a lattice sandwich structure, or in a large size, or with a free-form surface. When a part prototyped by 3D printing technology is sent to a tooling machine for further processing, there are the following problems:

1). Clamping is very difficult, or after clamping, a large processing error is caused because the processing reference point can not be accurately positioned due to conversion of coordinates;

2). For parts of thin-wall structures, the lack of a surface to support the parts may cause stress deformation;

3). When some parts have a complex internal structure, processing is very difficult because the tools can not reach inside.

In view of the insufficiency of the existing technology, it is necessary to provide a composite printing device featuring multi-spindle high-energy-particle-beam deposition welding and milling, which can repeatedly conduct profile milling on the one-layer or multi-layer approximate shape using plasma deposition and combination technique. Thus, no further processing is required for the processed mechanical part This will solve such problems as clamping difficulty, large processing error, in-process deformation, and difficulty to process.

For solving the above-mentioned problem, the present invention provides a composite printing device featuring multi-spindle high-energy-particle-beam deposition welding and milling, comprising: a machine base, a workbench disposed on one side of the machine base, a multi-spindle milling device on one side of the workbench, the multi-spindle milling device including a milling base and a tool base, the milling base spaced from one side of the tool base, the milling base having a first rail and a second rail disposed on a lower side thereof, the first rail disposed perpendicular to the second rail and the first rail disposed above the second rail; the workbench having an ejector base spaced from one side thereof, the ejector base having a welding gun disposed thereon.

More preferably, wherein the workbench includes a turntable and a worktable fitted inside the turntable; the turntable includes two support plates arranged in parallel and disposed perpendicularly on the workbench, the worktable fitted between the support plates.

More preferably, wherein the worktable includes a brace table, the brace table configured with connecting arms on both sides, with one end of the connecting arms fitted on the support plate, and the other end of the connecting arm respectively connected to either side of the brace table.

More preferably, wherein the brace table configured with a processing rotary plate on its top.

More preferably, wherein the first rail includes a first slider on its lower side, the first slider fitted on the second rail, the first rail moving back and forth along the direction of the second rail; the milling base configured with a second slider on its lower side, the second slider fitted on the first rail, the milling base moving back and forth along the direction of the first rail.

More preferably, wherein the milling base includes a first base frame and a milling clamping fixture, the milling clamping fixture fitted on one side of the first base frame, the first base frame configured with a third rail on its one side, the milling clamping fixture configured with a third slider to match the third rail, the third slider fitted on the third rail, the milling clamping fixture moving back and forth along the third rail.

More preferably, wherein the milling clamping fixture includes a milling base and a high-speed milling head, the third slider fitted on one side of the milling base, the high-speed milling head configured on the lower end of the milling base.

More preferably, wherein the ejector base is fitted with a welding gun, the welding gun comprising a welding fixture and a welding nozzle, the welding fixture configured with a clamping column on one side, the welding nozzle fitted on the other side of the welding fixture: the ejector base is configured with a sensor, the sensor arranged on the lower side of the welding fixture.

More preferably, wherein the tool base includes a second base frame and a tool magazine, the tool magazine fixed on the second base frame, the tool magazine configured with a tool arm rack on its lower side, the tool magazine storing milling heads inside.

More preferably, wherein the machine base includes a hood on an upper side thereof, the hood configured with an observation window, the observation window made of a dark eye-protecting glass material for welding.

By adjusting the horizontal distance between the milling base and the workbench or ejector base through the guide of the first rail and second rail, the present invention makes it possible for the milling base to move to the upper side of the workbench or ejector base; and the milling clamp can hold the tool or welding gun to form a one-layer or multi-layer approximate shape on the workbench and to conduct profile milling, so as to obtain the right size and surface accuracy required for the mechanical part, removing the need for further processing and avoiding such problems as clamping difficulty, large processing error, in-process deformation, and difficulty to process.

### BRIEF DESCRIPTION OF THE DRAWINGS

FIG. 1 is a schematic view of the structure of the present invention;

FIG. 2 is a schematic view of the structure of the present invention from another perspective;

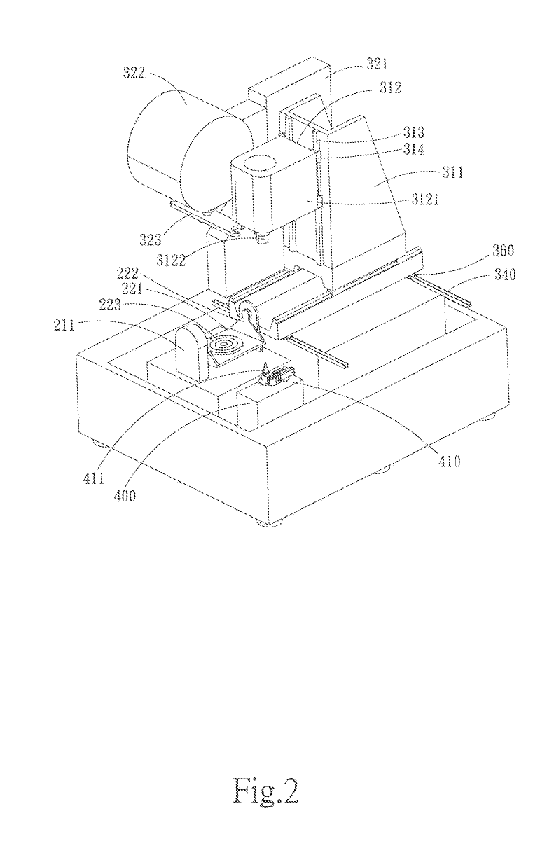

FIG. 3 is a schematic view of an ejector base of the present invention;

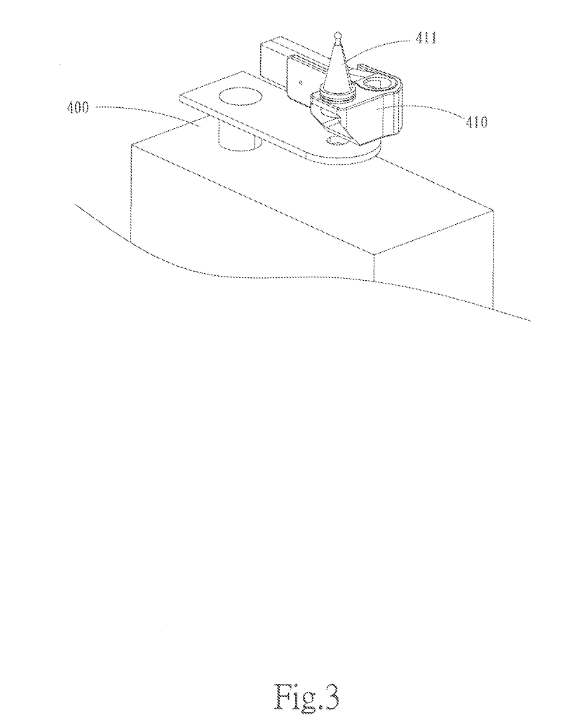

FIG. 4 is an exploded view of the ejector base of the present invention.

### DETAILED DESCRIPTION OF THE INVENTION

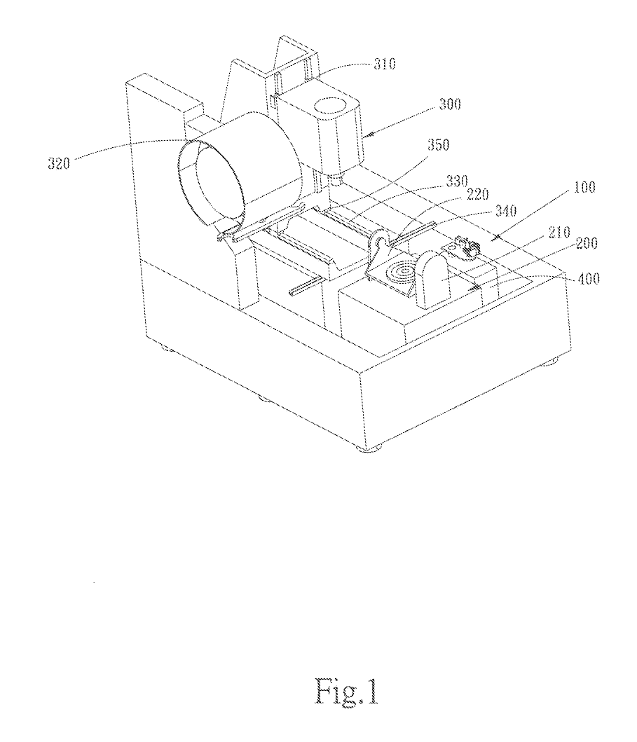

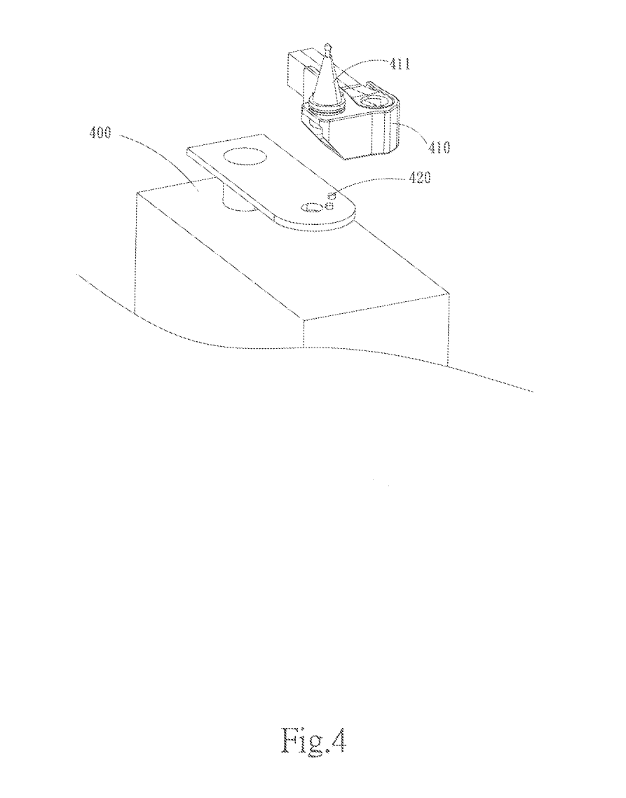

As disclosed in FIG. 1 and FIG. 4, the present invention of a composite printing device featuring multi-spindle high-energy-particle-beam deposition welding and milling comprises a machine base 100, the machine base 100 configured with a workbench 200 on its one side, the workbench 200 configured with a multispindle milling device 300 on its one side, the workbench 200 configured with a turntable 210 and a worktable 220, the worktable 220 fitted inside the turntable 210, the worktable 220 moving back and forth inside the turntable 210; in particular, the turntable 210 comprises two support plates 211 arranged in parallel, the support plates 211 configured on the workbench 200 perpendicularly, the worktable 220 fitted between the support plates 211, the worktable 220 configured with a brace table 221, the brace table 221 configured with connecting arms 222 on both sides, with one end of the connecting arm 222 fitted on the support plate 211, and the other end of the connecting arm 222 respectively connected to either side of the brace table 221, so as to drive the brace table 221 to move back and forth; the brace table 221 configured with a processing rotary plate 223 on its top, the processing rotary plate 223 being arranged to place the metal body formed layer after layer; in particular, the processing rotary plate 223 is configured with a high-temperature-resistant insulation pad on its top, to avoid heat transfer to the machine base 100 during the additive manufacturing process, which may lead to thermal expansion causing geometric errors.

The workbench 200 is configured with an ejector base 400 on its one side at an interval, the ejector base 400 fitted with a welding gun 410, the welding gun 410 uses beam of high-energy particles as heat source, to ensure perfect deposition of the metal powder, and concentration of the heat energy, while maintaining a low cost of equipment and operation; in particular, the beam of high-energy particles can be plasma beam, laser beam or high-power electron beam, the welding gun 410 comprising a welding fixture 411 and a welding nozzle (not shown in the drawings), the welding fixture 411 configured with a clamping column 4111 on one side, the welding nozzle fitted on the other side of the welding fixture 411; the ejector base 400 is configured with a sensor 420, the sensor 420 arranged on the lower side of the welding fixture 411. When the welding nozzle is placed on the ejector base 400, the welding fixture 411 will apply a force on the sensor 420, and the sensor 420 will sense that the welding gun 410 is not in operation. This can avoid human errors caused by confusion between additive manufacturing and subtractive manufacturing.

The multi-spindle milling device 300 is configured on the other side of the machine base 100, the multi-spindle milling device 300 comprising a milling base 310 and a tool base 320, the milling base 310 and tool base 320 being arranged side by side, the milling base 310 configured on one side of the tool base 320 at an interval, the milling base 310 moving in the x/y horizontal direction. Ins particular, the milling base 310 is configured with a first rail 330 and a second rail 340 on its lower side, the first rail 330 and second rail 340 configured perpendicularly, the first rail 330 configured on the upper side of the second rail 340, the first rail 330 configured with a first slider 350 on its lower side, the first slider 350 fitted on the second rail 340, the first rail 330 moves back and forth along the direction of the second rail 340; the milling base 310 is configured with a second slider 360 on its lower side, the second slider 360 fitted on the first rail 330, the milling base 310 moving back and forth along the direction of the first rail 330; the milling base 310 is configured with a first base frame 311 and a milling clamping fixture 312, the milling clamping fixture 312 fitted on one side of the first base frame 311, the first base frame 311 configured with a third rail 313 on its one side, the milling clamping fixture 312 fixed with a third slider 314 to match the third rail 313, the third slider 314 fitted on the third rail 313, the milling clamping fixture 312 moving back and forth along the third rail 313, thus constituting a one-step prototyping device with mum-spindle high-energy-particle-beam deposition welding and multi-spindle machine-tooling to manufacture precision metal parts.

The milling clamping fixture 312 comprises a milling base 3121 and a milling clamp 3122, the third slider 314 fitted on one side of the milling base 3121, the milling clamp 3122 configured on the lower end of the milling base 3121, the milling clamp 3122 able to clamp a tool or a welding gun 410. In particular, the milling clamp 3122 holds a welding gun 410 to form a metal body layer after layer on the processing rotary plate 233, or, the milling clamp 3122 holds a tool to conduct profile milling on the one-layer or multi-layer approximate shape formed through deposition welding on the processing rotary plate 233. During the additive manufacturing stage, the metal body is formed through deposition welding on the processing rotary plate 233. The metal body formed through deposition welding has a mechanical strength high enough to endure the force of machine tooling. Therefore, there is no need for a special clamp to hold and fix the metal body, and meanwhile, the mechanical origin of the metal body does not need resetting. That is to say, the axial lines of the welding nozzle and the machine tooling are almost in coincidence during the additive manufacturing or the subtractive manufacturing. As the original points of the additive manufacturing and subtractive manufacturing are almost the same, the accuracy of machine tooling; is ensured. Thus, 3D printing of the metal body and machine tooling of the metal body formed through deposition welding into a metal part can be completed in one step. The production speed of deposition welding is 10 to 20 times faster than traditional metal 3D printing. With a high powder utilization rate and no need to generate superfluous supporting points, the product manufacturing processes are dramatically reduced, and the production efficiency is enhanced. Powder mixtures of different materials can be used for alloy deposition welding to produce alloy workpieces with expected properties. The surface of a workpiece can reach the fineness of a casting, and the mechanical properties like density, hardness, and tensile strength can reach those o f a casting made of the same material.

When the milling base 310 needs to conduct welding, the milling base 310 moves to the upper side of the ejector base 400 under the influence of the first rail 330 and second rail 340. Meanwhile, the milling clamping fixture 312 moves downward along the third rail 313 to the upper side of the ejector base 400, the milling clamp 3122 is aligned to the clamping column 4111 and clamps the welding gun 410. Now, the welding fixture 411 moves away from the ejector base 400 under the drive of the milling clamp, and the sensor 420 senses that the welding fixture 411 is in operation, thus making sure that human error will not occur during the additive manufacturing; also, separate disposition of the welding gun 410 and tool can fully utilize the space, and have less interference to the metal body formed through disposition. During machine tooling of the metal body, the movement of the tool will not be impeded.

The tool base 320 comprises a second base frame 321 and a tool magazine 322, the tool magazine 322 fixed on the second base frame 321, the tool magazine 322 configured with a tool arm rack 323 on its lower side, the tool magazine 322 storing different milling heads, the tool arm rack 323 able to extract different milling heads from the tool magazine 322 as needed for the milling base 310. When the milling base 310 needs to change a milling head, the first rail 330 moves along the second rail 340 toward the side of the tool base 320. At this time, the milling base 310 will move simultaneously along the first rail 330 toward the tool base 320. The tool arm rack 323 will be at the same level as the lower end of the milling base 3121, making it easier to replace the milling clamp 3122 on the lower end of the milling base 3121, and consequently replace the tool. In this way, the efficiency of the multi-spindle milling device 300 with movable column and separate installation of the tool magazine is greatly enhanced.

In the above embodiment, the machine base 100 is configured with a hood on its upper side (not shown in the drawings), with the hood having an observation window. The observation window is made of a dark eye-protecting glass material for welding, to avoid dazzle and pollution of intense light, and meanwhile protect the eyes of the operator.

In the above embodiment, the present invention is also provided with at least 2 cameras and displayers, through which the actual operation after the milling clamping fixture 312 has clamped the welding gun or tool can be clearly observed without dazzle of strong light.

In the above embodiment, the welding gun is configured with an infrared non-contact temperature detector on its one side, which can detect and feedback the temperature in the deposition welding zone in real time, so that the temperature generated by the welding gun can be controlled to enhance manufacturing quality of the product.

In the above embodiment, the present invention adopts a closed construction, with combination of the machine base 100 and hood to form a closed space to effectively avoid spillover of the powder. The composite printing device featuring multi-spindle high-energy-particle-beam deposition welding and milling is installed with a filtering ventilation unit to avoid pollution of smog and dust to the environment, and to recycle the precious metal powder.

The present invention has the following detailed operational processes: under the drive of the first slider 350 and second slider 360, the guidance of the first rail 330 and second rail 340 can adjust the horizontal distance between the milling base 310 and the workbench 200 or the ejector base 400, and the guidance of the third rail 313 can adjust the vertical distance between the milling clamping fixture 312 and the workbench 200 or the ejector base 400, so that the milling clamping fixture 312 can move upward to the upper side of the workbench 200 or the ejector base 400; Firstly, 1) the first rail 330, second rail 340 and third rail 313 control and adjust the distance between the milling clamping fixture 312 and the ejector base 400, so that the milling clamping fixture 312 is aligned to the clamping column 4111 and clamps the welding gun 410. Now, under the drive of the milling clamp, the welding fixture 411 goes away from the ejector base 400, and the sensor 420 senses that the welding fixture 411 is in operation, and the welding gun 410 is moved to the upper side of the processing rotary plate 233. Through the welding nozzle, the introduced metal powder is molten and deposited onto the workbench 200, line after line and layer after layer, to form, a one-layer or multi-layer approximate shape; 2) By controlling the first rail 330, second rail 340 and third rail 313, the distance between the milling clamping fixture 312 and the ejector base 400 is adjusted, so that the milling clamping fixture 312 clamps the welding gun 410 on the ejector base 400, and the sensor 420 senses that the welding fixture 411 is not in operation. Then by controlling the distance between the milling clamping fixture 312 and tool arm rack 323, the milling clamping fixture 312 clamps the tool as needed to conduct profile milling on the one-layer or multi-layer approximate shape on the processing rotary plate 233, to achieve the size and surface fineness needed for the workpiece: 3) Repeat the above Step 1) and 2), till completion of the profiling of the ultimate part. This method can produce complex chambers or precision workpieces with a small mouth and a big cavity like a beer bottle that general tooling machines are unable to produce.

When it is needed to replace the milling clamp 3122, the guidance of the third rail 313 controls the milling clamp 3122 to be positioned at the same horizontal level as the tool arm rack 323. And the guidance of the first rail 330 and second rail 340 controls the milling clamp 3122 to be aligned with the tool arm rack 323, to replace a milling head stored on the tool arm rack 323, to complete shift of the milling clamp 3122. This easy, simple and convenient operation can help enhance the product manufacturing efficiency.

To summarize, through guidance of the first rail 330 and second rail 340, the present invention adjusts the horizontal distance between the milling base 310 and the workbench 200 or the ejector base 400, so that the milling base 310 is moved to the upper side of the workbench 200 or the ejector base 400; the milling clamp 3122 clamps the tool or welding gun 410 to conduct profile milling on the one-layer or multi-layer approximate shape formed on the workbench 200, to achieve the size and surface fineness needed for the workpiece. Thus, no further processing is required for the processed mechanical part. This will solve such problems as clamping difficulty, large processing error, in-process deformation, and difficulty to process.

The above only describes some exemplary embodiments of the present, invention. Those having ordinary skills in the art may also make many modifications and improvements without departing from the conception of the invention, which shall all fall within the protection scope of the invention.

We claim:

1. A composite printing device featuring multi-spindle high-energy-particle-beam deposition welding and milling, comprising:
a machine base, a workbench disposed on one side of the machine base, a multi-spindle milling device on one side of the workbench, the multi-spindle milling device including a milling base and a tool base, the milling base spaced from one side of the tool base, the milling base having a first rail and a second rail disposed on a lower side thereof, the first rail disposed perpendicular to the second rail and the first rail disposed above the second rail; the workbench having an ejector base spaced from one side thereof, the ejector base having a welding gun disposed thereon.

2. The composite printing device featuring multi-spindle high-energy-particle-beam deposition welding arid milling according to claim 1, wherein the workbench includes a turntable and a work table fitted inside the turntable; the turntable includes two support plates arranged in parallel and disposed perpendicularly on the workbench, the worktable fitted between the support plates.

3. The composite printing device featuring multi-spindle high-energy-particle-beam deposition welding and milling according to claim 2, wherein the worktable includes a brace table, the brace table configured with connecting arms on both sides, with one end of the connecting arms fitted on the support plate, and the other end of the connecting arm respectively connected to either side of the brace table.

4. The composite printing device featuring multi-spindle high-energy-particle-beam deposition welding and milling according to claim 3, wherein the brace table configured with a processing rotary plate on its top.

5. The composite printing device featuring multi-spindle high-energy-article-beam deposition welding and milling according to claim 1, wherein the first rail includes a first slider on its lower side, the first slider fitted on the second rail, the first rail moving back and forth along the direction of the second rail; the milling base configured with a second slider on its lower side, the second slider fitted on the first rail, the milling base moving back and forth along the direction of the first rail.

6. The composite printing device featuring multi-spindle high-energy-particle-beam deposition welding and milling according to claim 1, wherein the milling base includes a first base frame and a milling clamping fixture, the milling clamping fixture fitted on one side of the first base frame, the first base frame configured with a third rail on its one side, the milling clamping fixture configured with a third slider to match the third rail, the third slider fitted on the third rail, the milling clamping fixture moving back and forth along the third rail.

7. The composite printing device featuring multi-spindle high-energy-particle-beam deposition welding and milling according to claim 6, wherein the milling clamping fixture includes a milling base and a high-speed milling head, the third slider fitted on one side of the milling base, the high-speed milling head configured on the lower end of the milling base.

8. The composite printing device featuring multi-spindle high-energy-particle-beam deposition welding and milling according to claim 1, wherein the ejector base is fitted with a welding gun, the welding gun comprising a welding fixture and a welding nozzle, the welding fixture configured with a clamping column on one side, the welding nozzle fitted on the other side of the welding fixture; the ejector base is configured with a sensor, the sensor arranged on the lower side of the welding fixture,

9. The composite printing device featuring multi-spindle high-energy-particle-beam deposition welding and milling according to claim 1, wherein the tool base includes a second base frame and a tool magazine, the tool magazine fixed on the second base frame, the tool magazine configured with a tool arm rack on its lower side, the tool magazine storing milling heads inside.

10. The composite printing device featuring multi-spindle high-energy-particle-beam deposition welding and milling according to claim 1, wherein the machine base includes a hood on an upper side thereof, the hood configured with an observation window, the observation window made of a dark eye-protecting glass material for welding.
